(19) United States
(12) Patent Application Publication
(10) Pub. No.: US 2012/0306194 A1
(43) Pub. Date: Dec. 6, 2012

(54) PIPE CONNECTION BLOCK

(75) Inventor: CHING-HSIU MA, CHIA YI COUNTY (TW)

(73) Assignee: TOWER GLOBAL CO., LTD., CHIA YI COUNTY (TW)

(21) Appl. No.: 13/152,322

(22) Filed: Jun. 3, 2011

(51) Int. Cl. F16L 39/00

(52) U.S. Cl. 285/130.1

(57) ABSTRACT

A connection block is revealed. The connection block includes a main body, at least two sleeve joint segments extending from a periphery of the main body, and at least one reinforcement part set between the main body and the sleeve joint segment. The sleeve joint segment is disposed with at least one slot. Thereby the connection block is stronger, not damaged or cracked easily. When the connection block and a pipe are connected, the sleeve joint segment is compressed a bit due to the slot and then is connected to an inner surface of the pipe securely by a recovery force of the sleeve joint segment. The assembling is easier and the connection is more stable. The connection block is with better practical value.

### BACKGROUND OF THE INVENTION

1. Field of the Invention

The present invention relates to a pipe connection block, especially to a pipe connection block that is durable, not easy to get damaged or broken. Moreover, the pipe connection block makes the connection and positioning of pipes become easier and more convenient. The pipe connection block has better practical value.

2. Description of Related Art

Generally, in our daily lives, various pipes are used as supports in many racks, kitchen cabinets, furniture, etc. The pipes are also applied to packaging and organization due to its portability. The pipe is formed by a plurality of segments. A connection block is used to connect the two adjacent pipes when users intend to use the device.

The connection block that connects pipes includes a main block and projective connection parts extending from the main block. Each connection part is corresponding to a pipe. While assembling the pipes, each pipe is connected to the corresponding connection part. Then the pipe and the connection part are connected with each other firmly by threaded fasteners. The assembling of the pipes is completed.

Although the connection block mentioned above connects the pipes, having the expected effect, the following shortcomings are found while in use:
1. After being connected, the angle between the main block and the connection part is a right angle. Thus the connection area between each connection part and the main block is easy to get damaged or broken due to collision or inappropriate force applied. There is room for improvement.
2. After the each connection part around the main block being corresponding with a corresponding pipe, one more step is needed to complete the assembling. Threaded fasteners are threaded into the connection part and the main block for secure connection. This is trouble and inconvenient.

Thus there is a need to provide a novel pipe connection block that overcomes the above disadvantages and having better practical value.

### SUMMARY OF THE INVENTION

Therefore it is a primary object of the present invention to provide a pipe connection block by which the connection/positioning between pipes are more convenient and stable. The pipe connection block has better practical value.

In order to achieve the above object, the pipe connection block of the present invention consists of a main body, at least two sleeve joint segments extending and projecting from a periphery of the main body and at least one projective reinforcement part disposed between the main body and the sleeve joint segment. The sleeve joint segment is arranged with at least one slot. Thereby the connection block is stronger, not easily damaged or broken. While connecting the pipe with the connection block, the sleeve joint segment is compressed a bit due to the slot. Then the sleeve joint segment is connected to an inner surface of the pipe tightly by a recovery force thereof. The assembly is stable and secure.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of an embodiment according to the present invention;

FIG. 2 is a perspective view of another embodiment according to the present invention;

FIG. 3 is a perspective view of a further embodiment according to the present invention;

FIG. 4 is a perspective view of a further embodiment according to the present invention;

FIG. 5 is a partial schematic drawing showing an embodiment in use according to the present invention;

FIG. 6 is a partial schematic drawing showing cross section of an embodiment in use according to the present invention.

### DETAILED DESCRIPTION OF THE PREFERRED EMBODIMENT

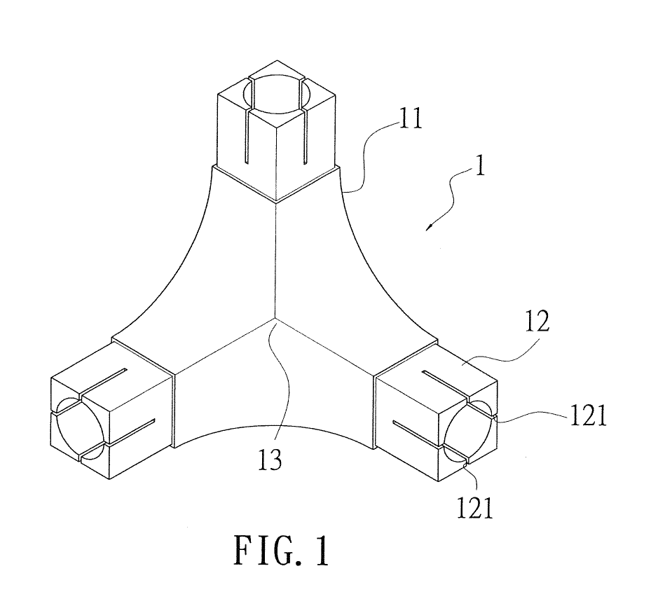

Refer to FIG. 1, a connection block 1 of the present invention mainly includes a main body 11, at least two sleeve joint segments 12 extending and projecting from a periphery of the main body 11 and at least one projective reinforcement part 13 disposed between the main body 11 and the sleeve joint segment 12. The sleeve joint segment 12 is mounted with at least one slot 121.

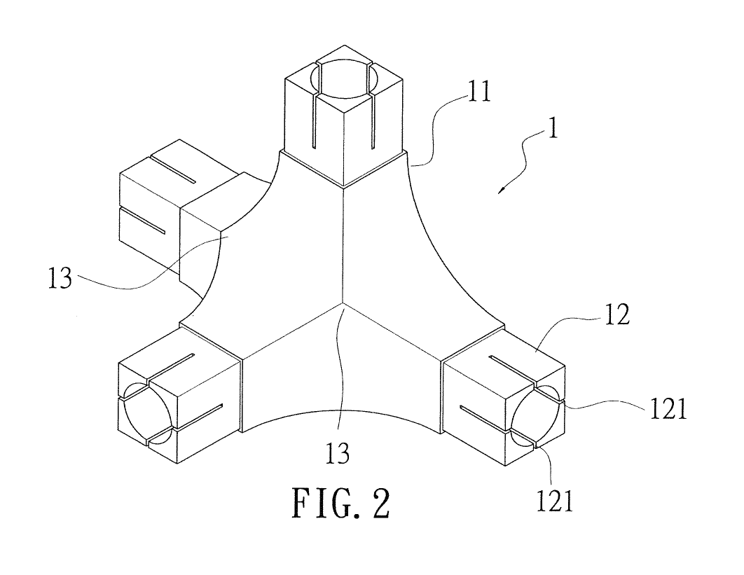

The respective sleeve joint segments 12 projecting from a periphery of the main body 11 extend to different directions. For example, refer to FIG. 1, the sleeve joint segments 12 three different directions respectively in this embodiment. Or the sleeve joint segments 12 extend to four different directions respectively in the embodiment shown in FIG. 2. The respective sleeve joint segments 12 can also extend to two different directions, five different directions, or multiple directions.

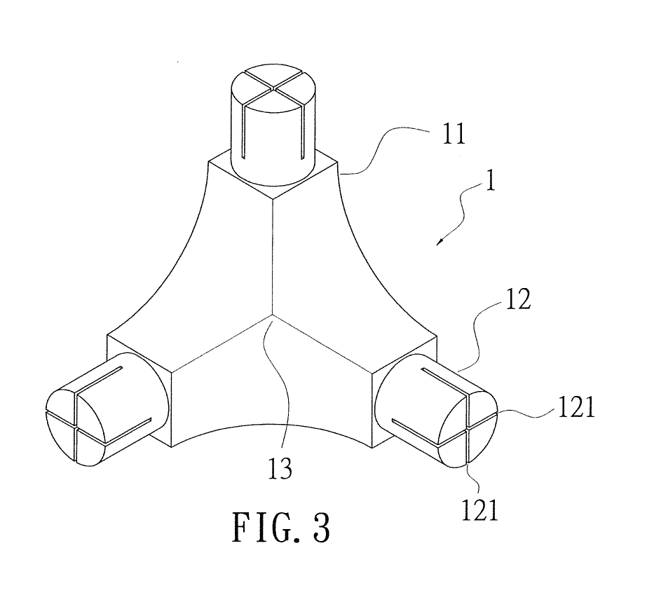

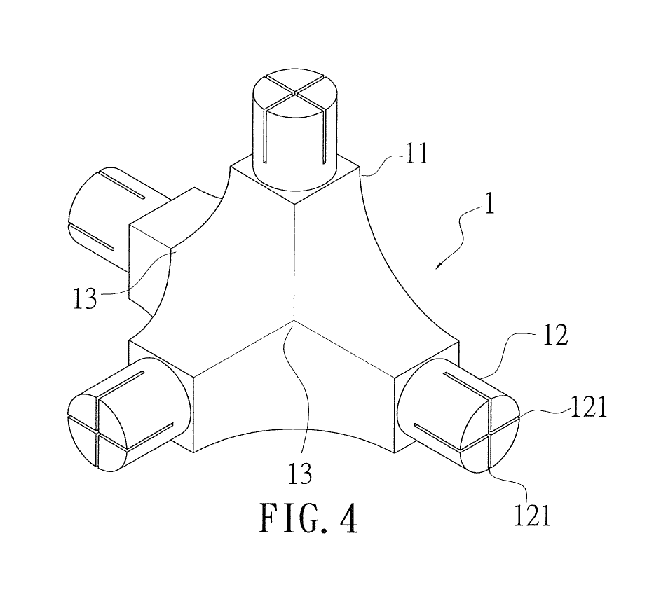

Moreover, the cross section of the sleeve joint segment 12 extending from a periphery of the main body 11 of the connection block 1 can be rectangular (as the embodiment in FIG. 1 and FIG. 2) or circular (as the embodiment shown in FIG. 3 and FIG. 4). The cross section of the sleeve joint segment 12 can also be triangular or polygonal, etc., not limited to these shapes.

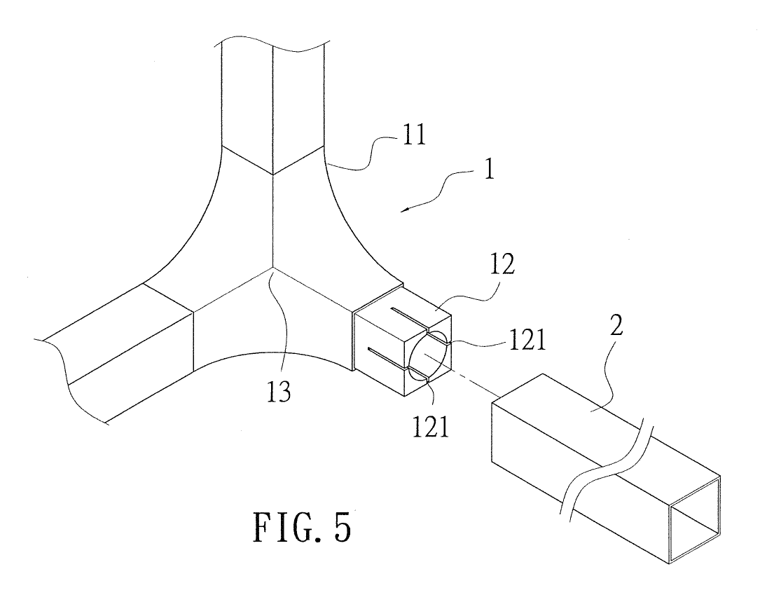

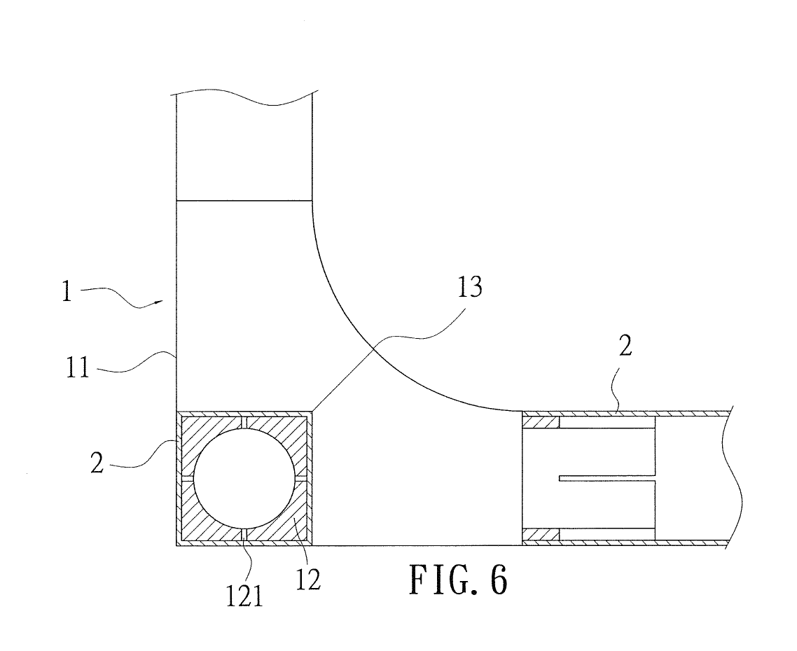

In use, refer to FIG. 5 and FIG. 6, each pipe 2 is sleeved on and connected to the sleeve joint segment 12 on the periphery of the main body 11 of the connection block 1. The inner diameter of the pipe 2 is a little bit smaller than the outer diameter of the sleeve joint segment 12 so that the sleeve joint segment 12 is compressed a bit by the pipe 2 due to the slots 121 while the pipe 2 and the sleeve joint segment 12 connecting to each other. By a recovery force of the sleeve joint segment 12, the sleeve joint segment 12 is positioned in and connected to an inner surface of the pipe 2 tightly and securely, not falling off. Thus the pipes 2 are connected with each other solidly.

In summary, compared with the structure available now, the present invention has following advantages:
1. The projective reinforcement part arranged between the main body and the sleeve joint segment of the connection block enables each sleeve joint segment stronger. Thus the area between the main body and the sleeve joint segment will not get damaged or broken easily.
2. The sleeve joint segment of the connection block is arranged with at least one slot. Thus the sleeve joint segment is compressed a bit due to each slot when the sleeve joint segment and the pipe are connected to each other. By the recovery force, the sleeve joint segment and the inner surface of the pipe are positioned and connected with each other firmly. The assembly and connection of each pipe are easier and more convenient.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

What is claimed is:

1. A pipe connection block comprising:
a main body, at least two sleeve joint segments extending and projecting from a periphery of the main body; the sleeve joint segment being mounted with at least one slot; and
at least one projective reinforcement part disposed between the main body and the sleeve joint segment.
